(19) United States
(12) Patent Application Publication
(10) Pub. No.: US 2020/0019110 A1
(43) Pub. Date: Jan. 16, 2020

(54) IMAGE FORMING APPARATUS

(71) Applicant: FUJI XEROX CO., LTD., Tokyo (JP)

(72) Inventor: Yasutaka MATSUMOTO, Kanagawa (JP)

(73) Assignee: FUJI XEROX CO., LTD., Tokyo (JP)

(21) Appl. No.: 16/260,148

(22) Filed: Jan. 29, 2019

(30) Foreign Application Priority Data
Jul. 13, 2018 (JP) 2018-133165

(51) Int. Cl. G03G 21/00; G03G 15/16; G03G 21/18

(52) U.S. Cl. CPC G03G 21/0023; G03G 15/161; G03G 2215/0154; G03G 21/1867; G03G 15/1615

(57) ABSTRACT

An image forming apparatus includes: an image carrier that carries a toner image on a surface thereof while rotating, from which the toner image is transferred to a transfer member; a scraper that comes into contact with an area of the surface of the image carrier from which the toner image has been transferred and that scrapes residue off the image carrier; and a flattening device that flattens a pile of residue that has been scraped off by the scraper and has accumulated.

### CROSS-REFERENCE TO RELATED APPLICATIONS

This application is based on and claims priority under 35 USC 119 from Japanese Patent Application No. 2018-133165 filed Jul. 13, 2018.

### BACKGROUND

### (i) Technical Field

The present disclosure relates to image forming apparatuses.

### (ii) Related Art

In a widely used configuration, a scraper, such as a cleaning blade, comes into contact with an image carrier, which holds a toner image, at an area from which the toner image has been transferred, and scrapes post-transfer residue off the image carrier. Toner contains external-additive particles, which appropriately pass through a contact portion between the image carrier and the scraper. The external-additive particles serve as lubricant to maintain proper friction between the image carrier and the scraper.

Japanese Unexamined Patent Application Publication No. 4-090585 discloses a configuration in which accumulated residual toner between the image carrier and the scraper is moved by reversely rotating the image carrier (photoconductor) and is then scraped off by a cleaning member, which is a separate member from the scraper and is provided at a position to which the residual toner is moved.

In recent years, durable image carriers, which have hard surfaces, are being developed. Some of such image carriers having hard surfaces strongly inhibits passing of external-additive particles through the contact portion between the image carrier and the scraper. In such image carriers, the amount of the external-additive particles, serving as lubricant, on the surface of the image carrier tends to be insufficient. If the amount of the external-additive particles becomes insufficient, the friction between the image carrier and the scraper may increase, resulting in excessive wear of the scraper.

### SUMMARY

Aspects of non-limiting embodiments of the present disclosure relate to an image forming apparatus in which passing of the external-additive particles through an area between the image carrier and the scraper is promoted, compared with a configuration in which a pile of post-transfer residue, which has been scraped off by the scraper and has accumulated, is left without being flattened.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including: an image carrier that carries a toner image on a surface thereof while rotating, from which the toner image is transferred to a transfer member; a scraper that comes into contact with an area of the surface of the image carrier from which the toner image has been transferred and that scrapes residue off the image carrier; and a flattening device that flattens a pile of residue that has been scraped off by the scraper and has accumulated.

### BRIEF DESCRIPTION OF THE DRAWINGS

Exemplary embodiment of the present disclosure will be described in detail based on the following figures, wherein:

FIG. 1 schematically shows the configuration of a copier, which corresponds to an exemplary embodiment of an image forming apparatus of the present disclosure;

FIG. 2 schematically shows a blade scraping residual toner off an image carrier after a toner image has been transferred;

FIG. 3 schematically shows a flattened toner dam;

FIG. 4 schematically shows an image forming engine;

FIGS. 5A to 5C each show an alternating-current component of a charging bias voltage;

FIG. 6 shows the toner-dam flattening level, which varies with the amplitude or the repetition frequency of the charging bias voltage applied to the charger;

FIG. 7 schematically shows an image forming engine;

FIG. 8 shows advantages obtained by flattening the toner dam;

FIG. 9 schematically shows an image forming engine;

FIG. 10 schematically shows an image forming engine;

FIG. 11 is a side view showing the right sides of a cleaner and the image carrier as viewed from, for example, the left side in FIG. 10;

FIG. 12 schematically shows an image forming engine;

FIG. 13 schematically shows the cleaner before and after the rotation;

FIG. 14 is a schematic partial view of the cleaner of the image forming engine;

FIG. 15 schematically shows an image forming engine; and

FIG. 16 is a schematic partial view of the cleaner of the image forming engine.

### DETAILED DESCRIPTION

Exemplary embodiments of the present disclosure will be described below.

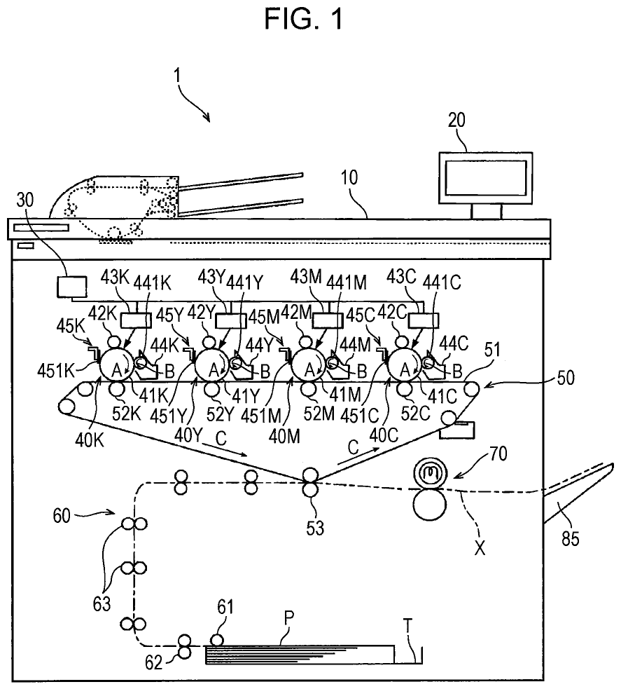

FIG. 1 schematically shows the configuration of a copier, which corresponds to an exemplary embodiment of an image forming apparatus of the present disclosure.

A copier 1 is a so-called tandem color copier. The copier 1 includes, at the top thereof, an image reading unit 10, which reads an image from an original document, and a user interface (UI) 20.

The image reading unit 10 has a built-in image reading sensor, which reads the image on the original document set in the image reading unit 10 and generates image data.

The user interface (UI) 20 has a touch-panel display screen, which displays various information and through which a user inputs instructions.

The copier 1 includes a controller 30, which controls the overall operation of the copier 1.

The controller 30 also obtains image data from the image reading unit 10 and performs image processing on that image data.

The copier 1 includes: four image forming engines 40C, 40M, 40Y, and 40K, which form color toner images corresponding to the image data sent from the controller 30 and representing images of the respective colors (for example, cyan (C), magenta (M), yellow (Y), and black (K)); a transfer unit 50, which transfers the toner images to a sheet P; and a sheet transport unit 60, which transports the sheet P along a transport path X.

The image forming engines 40C, 40M, 40Y, and 40K form the toner images using an electrophotographic system. The four image forming engines 40C, 40M, 40Y, and 40K have the same structure. Hence, in the common descriptions of the four image forming engines 40C, 40M, 40Y, and 40K, the letters C, M, Y, and K representing the respective colors are omitted, and the image forming engine 40C, 40M, 40Y, or 40K will be called the “image forming engine 40”. The same is true for the components of the image forming engine 40 and the other components of the copier 1.

Each of the image forming engines 40 includes a cylindrical image carrier 41, which rotates in the arrow A direction. While the image carrier 41 is rotating, an electrostatic latent image is formed on the surface thereof. The electrostatic latent image is developed with toner into a toner image, and the toner image is temporarily held on the image carrier 41.

The image forming engine 40 includes a charger 42, an exposure device 43, a developing device 44, and a cleaner 45, which are provided around the image carrier 41.

The charger 42 is a charging roller that rotates while being in contact with the image carrier 41. The charger 42 charges the surface of the image carrier 41 by receiving the supply of a charging bias voltage.

The exposure device 43 receives image data of the corresponding color from the controller 30 and radiates exposure light modulated according to the received image data onto the image carrier 41 to form an electrostatic latent image on the image carrier 41.

The developing device 44 includes a developing roller 441 and accommodates developer, which contains toner and carrier. While rotating in the arrow B direction, the developing roller 441, which has a cylindrical shape, holds the developer accommodated in the developing device 44 on the surface thereof and transports the developer to a developing position, at which the developing roller 441 faces the image carrier 41. The developing roller 441 develops the electrostatic latent image on the image carrier 41 with the toner in the developer.

The electrostatic latent image formed on the image carrier 41 as a result of being developed by the developing roller 441 is transferred to a sheet P transported thereto, by the transfer unit 50.

The residual toner left on the image carrier 41 after the transfer is scraped off from the image carrier 41 by a blade 451, which constitutes the cleaner 45, and is collected in a waste toner tank (not shown).

The transfer unit 50 includes: an endless transfer belt 51, which revolves in the arrow C direction; a first-transfer device 52, which transfers the toner image from the image carrier 41 to the transfer belt 51; and a second-transfer device 53, which transfers the toner image from the transfer belt 51 to the sheet P.

The sheet transport unit 60 includes: a pickup roller 61 that picks up sheets P from a sheet tray T, a separating roller 62 that separates the sheets P into individual sheets P and feeds one sheet P to a transport path X; and multiple transport rollers 63, which transport the sheet P along the transport path X.

A fixing device 70 is provided on the transport path X of the copier 1. A paper output tray 85 is provided at the end of the transport path X.

The fixing device 70 fixes the toner image to the sheet P by nipping the sheet P having the toner image transferred thereto between multiple members (herein, for example, rollers) and applying heat and pressure.

In a basic image forming operation of the copier 1, first, a user sets an original document on the image reading unit 10 and instructs start of copying through the UI 20. As a result, the image reading unit 10 reads the image on the original document and generates image data under the control by the controller 30. The image data obtained by reading the original document is transferred to the controller 30, where necessary image processing for image formation, such as color separation processing and screen processing, is performed on the image data. The image data corresponding to the respective colors, which is obtained through the image processing, is transferred from the controller 30 to the respective exposure devices 43, and electrostatic latent images corresponding to the respective colors are formed on the image carriers 41. Then, the electrostatic latent images are developed with toners into toner images. The toner images formed on the image carriers 41 are transferred to the transfer belt 51 in a superimposed manner, thus forming a color toner image. The color toner image is transferred to the sheet P transported by the sheet transport unit 60, and the sheet P is transported along the transport path X, passes through the fixing device 70, where the toner image is fixed to the sheet P, and is output on the paper output tray 85.

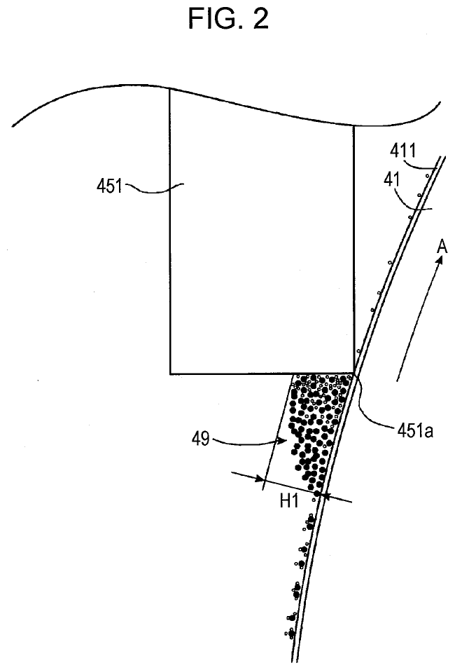

FIG. 2 schematically shows a blade scraping residual toner off an image carrier after a toner image has been transferred. In FIG. 2, black dots represent toner particles, and white dots represent external-additive particles, including those isolated from the toner particles (isolated external-additive particles). The external additive is added to the toner and is mainly composed of silica.

The residual toner left on the image carrier 41 after the transfer is transported in the arrow A direction as the image carrier 41 rotates and is scraped off from the image carrier 41 by the blade 451, forming a toner dam 49. The height of the toner dam 49 is H1. The toner particles spilled out of the toner dam 49 are transported to a waste toner tank (not shown) by a waste-toner collecting device (not shown).

The image carrier 41 according to this exemplary embodiment has a surface protection layer 411. The surface protection layer 411 has a higher hardness than the underlying layer. More specifically, the surface protection layer 411 according to this exemplary embodiment is formed of a material containing an element in group 13 of the periodic table. More specifically, the surface protection layer 411 according to this exemplary embodiment is composed of, at least, gallium and oxygen. Elements in group 13 tend to stably capture hydrogen. By capturing hydrogen, oxidation degradation is suppressed.

The external additive to the toner, which is mainly composed of silica, also serves as lubricant. The external-additive particles isolated from the toner pass under a contact portion 451a of the blade 451, at which the blade 451 is in contact with the image carrier 41. The isolated external-additive particles reduce the friction between the blade 451 and the image carrier 41 as they pass under the contact portion 451a. If the friction between the blade 451 and the image carrier 41 is large, wear of the blade 451 progresses, which reduces the life of the blade 451. Hence, when the blade 451 scrapes the residual toner off the image carrier 41, it is desirable that the friction be reduced by allowing the isolated external-additive particles to pass under the contact portion 451a.

However, the image carrier 41 according to this exemplary embodiment has a hard surface protection layer 411, which strongly inhibits passing of the isolated external-additive particles under the contact portion 451A of the blade 451. Hence, passing of the isolated external-additive particles needs to be promoted.

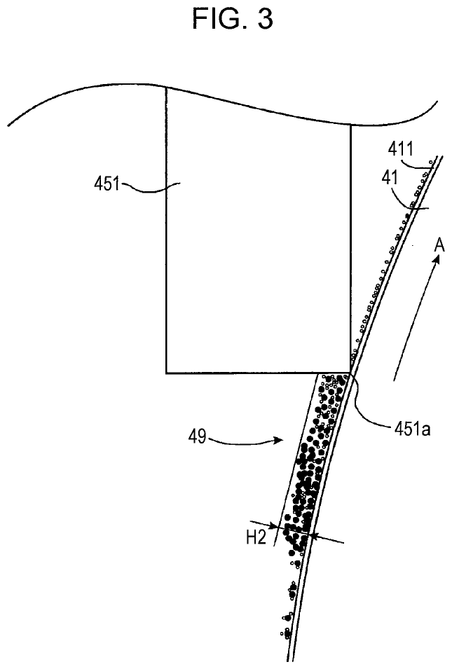

FIG. 3 schematically shows a flattened toner dam.

Through an experiment, the inventor has found that passing of the isolated external-additive particles is promoted by flattening the toner dam 49, which is formed as a result of the residual toner being scraped off by the blade 451 and accumulating, from the height H1 shown in FIG. 2 to the height H2 shown in FIG. 3, which is lower than the height H1. Devices for flattening the toner dam and advantages obtained by flattening the toner dam will be described below.

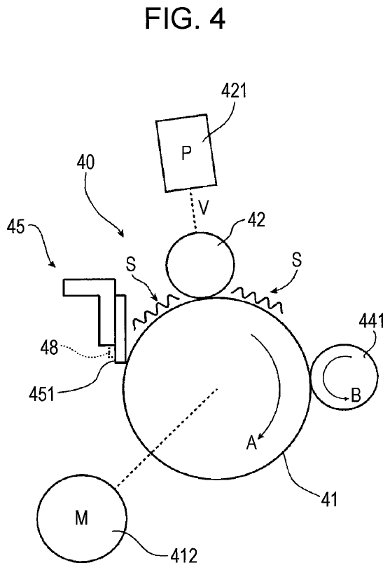

FIG. 4 schematically shows an image forming engine. Although FIG. 1 shows four image forming engines 40C, 40M, 40Y, and 40K, FIG. 4 shows one example image forming engine, in which the components are denoted by reference signs with no color-indicating letter C, M, Y, or K. FIG. 4 (as well as FIGS. 7 and 9 to 16 described below) does not illustrate some of the components of the image forming engine that are illustrated in FIG. 1, while illustrating some of the components that are not illustrated in FIG. 1.

Referring to FIG. 4, a first example of a flattening device of the present disclosure will be described.

The charger 42 is a contact-type charging roller. A power supply 421 applies a charging bias voltage V, in which an alternating-current (AC) component is superposed on a direct-current (DC) component, to the charger 42.

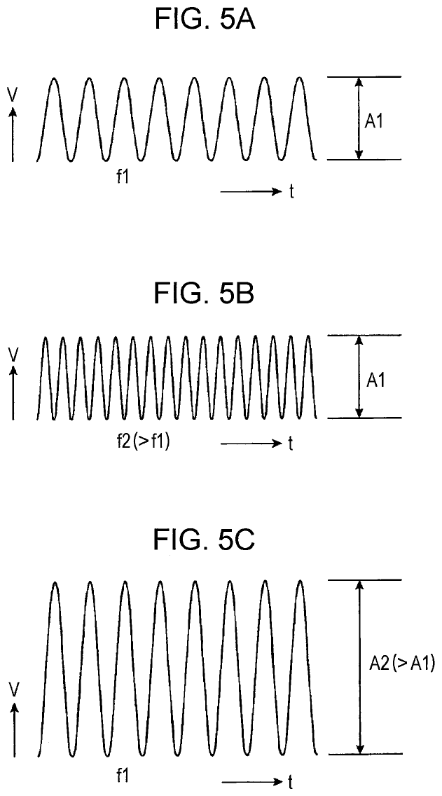

FIGS. 5A to 5C each show an alternating-current component of a charging bias voltage. In FIGS. 5A to 5C, the vertical axis represents the voltage V, and the horizontal axis represents the time axis t.

FIG. 5A shows the AC component of a charging bias voltage during image formation, in which the image forming engine 40 is performing an image forming operation. As shown in FIG. 5A, in the charging bias voltage V, the AC component, in which the voltage repeatedly changes with time in the form of a sine wave, is superposed on the DC component. In FIG. 5A, the amplitude (peak to peak) of the charging bias voltage is assumed to be A1, and the repetition frequency of the voltage change is assumed to be f1.

FIG. 5B shows a charging bias voltage that has the same amplitude as the amplitude, A2, of the charging bias voltage shown in FIG. 5A and that has a higher repetition frequency, f2, than the repetition frequency, f1, of the charging bias voltage shown in FIG. 5A.

FIG. 5C shows a charging bias voltage that has the same repetition frequency as the repetition frequency, f1, of the charging bias voltage shown in FIG. 5A and that has a greater amplitude, A2, than the amplitude, A1, of the charging bias voltage shown in FIG. 5A.

Herein, in a non-image-forming period, in which the image forming engine 40 is not performing an image forming operation, a developing bias voltage V with increased repetition frequency f or amplitude A, as shown in FIG. 5B or 5C, is applied to the developing device 42. As a result, as schematically shown in FIG. 4, a vibration S is generated in the image carrier 41 and propagates to the blade 451, and thus, the blade 451 also vibrates. Due to the vibration S, the toner dam 49 as shown in FIG. 2 is flattened as shown in FIG. 3. As a result, the external-additive particles isolated from the toner more easily pass under the contact portion 451a, reducing the friction between the image carrier 41 and the blade 451 and, thus, suppressing wear of the blade 451.

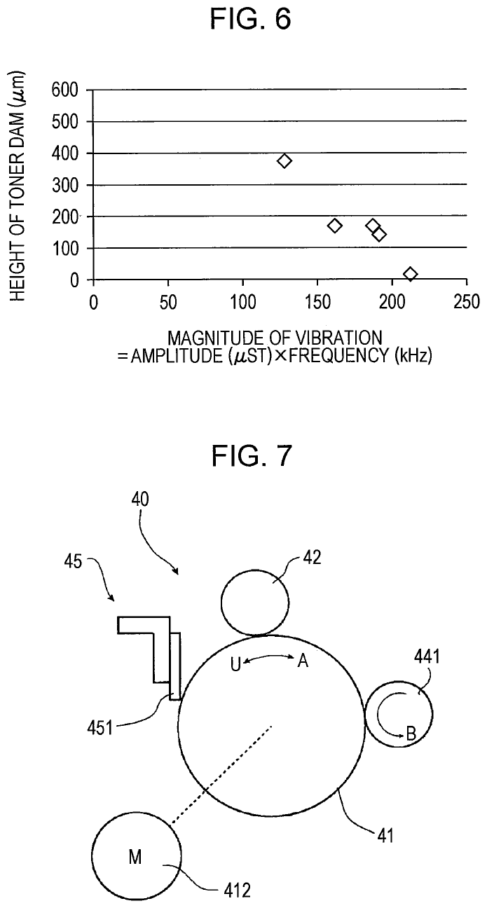

FIG. 6 shows the toner-dam flattening level, which varies with the amplitude or the repetition frequency of the charging bias voltage applied to the charger. In FIG. 6, the vertical axis represents the height (μm) of the toner dam, and the horizontal axis shows the magnitude of vibration (=amplitude (μST)×frequency (kHz)). The height of the toner dam corresponds to the height H1 in FIG. 2 or the height H2 in FIG. 3. The amplitude (μST) is the amount of distortion of the blade 451 occurring when a charging bias voltage is applied to the charger 42, which is measured by using a distortion sensor 48 attached to the blade 451 (see FIG. 4). The frequency (kHz) is the repetition frequency of the charging bias voltage.

FIG. 6 shows that: by changing the charging bias voltage as shown in FIGS. 5B or 5C to apply a vibration, the toner dam, which has a height of 500 μm when a charging bias voltage as shown in FIG. 5A is applied in image formation, is flattened; and that the toner dam is flattened more as the magnitude of vibration increases.

The charging bias voltage V may be changed as shown in FIG. 5B or 5C in a non-image-forming period. Alternatively, the charging bias voltage V may be changed in a non-image-forming period and when the rotation torque of the image carrier 41 has exceeded a predetermined threshold. The rotation torque of the image carrier 41 can be obtained by detecting the value of a current flowing through a motor 412, which rotates the image carrier 41 at a constant speed.

The device for changing the charging bias voltage V as shown in FIGS. 5B and 5C, which has been described with reference to FIGS. 4 and 5A to 5C, is an example of a vibration applying device, serving as the flattening device of the present disclosure. The device that detects the current flowing through the motor 412 to obtain the rotation torque of the image carrier 41 is an example of a torque sensor, serving as a detector of the present disclosure.

FIG. 7 schematically shows an image forming engine. Referring to FIG. 7, a second example of the flattening device of the present disclosure will be described.

The motor 412 for rotating the image carrier 41 is capable of reverse rotation. Alternatively, the motor 412 may be configured to be capable of rotation in the normal and reverse directions by means of, for example, switching of a gear.

In a non-image-forming period, the image carrier 41 is rotated in a reciprocating manner so as to vibrate in the arrow A direction and the arrow U direction. By doing so, the toner dam 49 (see FIG. 2) is flattened. The second example is an example of a device that causes the image carrier 41 to perform an operation including reverse rotation, which serves as the relative movement device of the present disclosure.

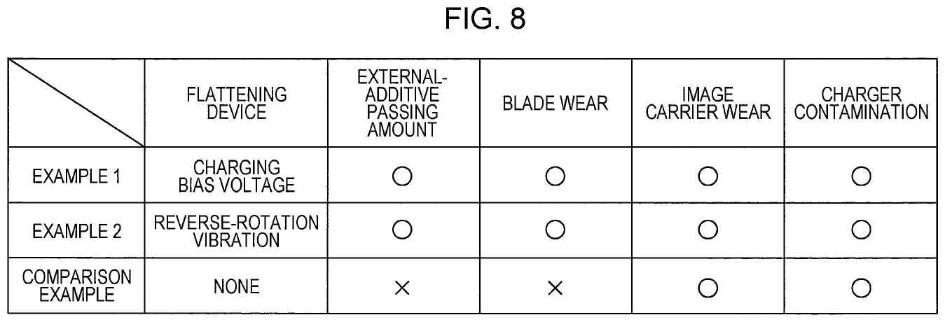

FIG. 8 shows advantages obtained by flattening the toner dam.

Example 1 shows the example described with reference to FIG. 4, in which the amplitude or repetition frequency of the charging bias voltage is changed to flatten the toner dam.

Example 2 shows the example described with reference to FIG. 7, in which the image carrier is rotated in the normal and reverse directions so as to vibrate the image carrier to flatten the toner dam.

Comparison example shows an example in which the toner dam is not flattened.

“External-additive passing amount”, “blade wear”, “image carrier wear”, and “charger contamination” are evaluated.

“External-additive passing amount” is evaluated by the number of the external-additive particles passing under the contact portion 451A of the blade 451 (see FIG. 2) per unit area of the surface of the image carrier.

“Blade wear” is evaluated by the rate at which the blade 451 wears due to the friction with the image carrier 41.

“Image carrier wear” is evaluated by the rate at which the image carrier 41 wears due to the friction with the blade 451.

“Charger contamination” is evaluated by the amount of the external-additive particles deposited on the charger 42. As the amount of the external-additive particles passing under the contact portion 451A increases, the amount of the external-additive particles deposited on the charger 42 increases. Because the external-additive particles deposited on the charger 42 may cause uneven charging of the image carrier 41, deposition of a large amount of the external-additive particles on the charger 42 needs to be avoided.

As shown in FIG. 8, by flattening the toner dam, the amount of the external-additive particles passing increases, and thus, wear of the blade 451 is suppressed. As described above, the image carrier 41 having the hard surface protection layer 411 (see FIG. 2) is used in this exemplary embodiment. Hence, even if the friction between the image carrier 41 and the blade 451 is increased not by flattening the toner dam, wear of the image carrier 41 is not problematic. Contamination of the charger 42 resulting from an increase in the amount of the external-additive particles passing under the contact portion 451A, which is caused by flattening the toner dam, is not problematic.

FIG. 8 shows that flattening the toner dam to increase the amount of the external-additive particles passing is effective in suppressing wear of the blade 451.

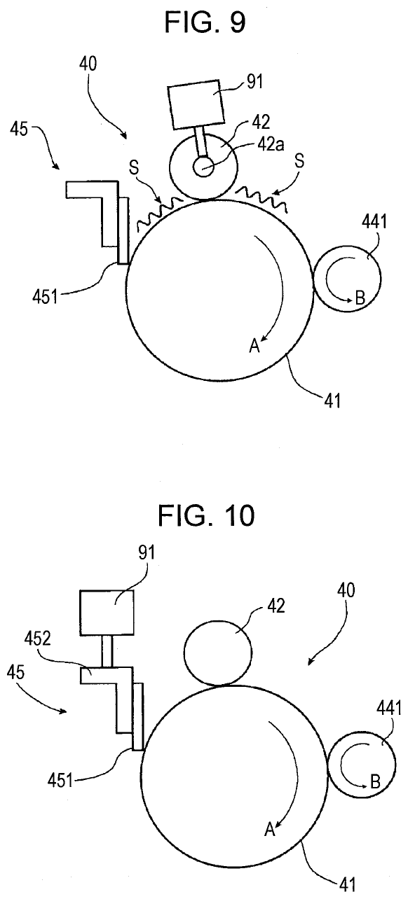

FIG. 9 schematically shows an image forming engine. Referring to FIG. 9, a third example of the flattening device of the present disclosure will be described.

FIG. 9 shows a vibration applying device 91 that applies mechanical vibration to the rotation shaft 42a of the charger 42. The vibration applying device 91 applies vibration either by means of an electromagnetic effect, such as on and off of the power supplied to a coil of an electromagnet, or by means of ultrasonic wave vibration generated by a piezoelectric element; any vibration applying method may be used. When the vibration applying device 91 vibrates the charger 42, the vibration S propagates to the image carrier 41 and then to the blade 451, flattening the toner dam 49 (see FIG. 2).

The vibration applying device 91 is an example of a mechanical vibration device, serving as the vibration applying device of the present disclosure.

FIG. 10 schematically shows an image forming engine. Referring to FIG. 10, a fourth example of the flattening device of the present disclosure will be described.

FIG. 10 shows the vibration applying device 91 for applying mechanical vibration, which is disposed so as to vibrate a support member 452 supporting the blade 451. When the vibration applying device 91 vibrates the support member 452 of the cleaner 45, the vibration propagates to the blade 451, flattening the toner dam 49 (see FIG. 2).

The vibration applying device 91 that vibrates the cleaner 45 is also an example of the mechanical vibration device, serving as the vibration applying device of the present disclosure.

Although two examples, in which the mechanical vibration device vibrates the charger 42 (see FIG. 9) and in which the mechanical vibration device vibrates the cleaner 54 (see FIG. 10), have been described, it is only necessary that the vibration propagates to the blade 451. Hence, the member for applying vibration is not specifically limited.

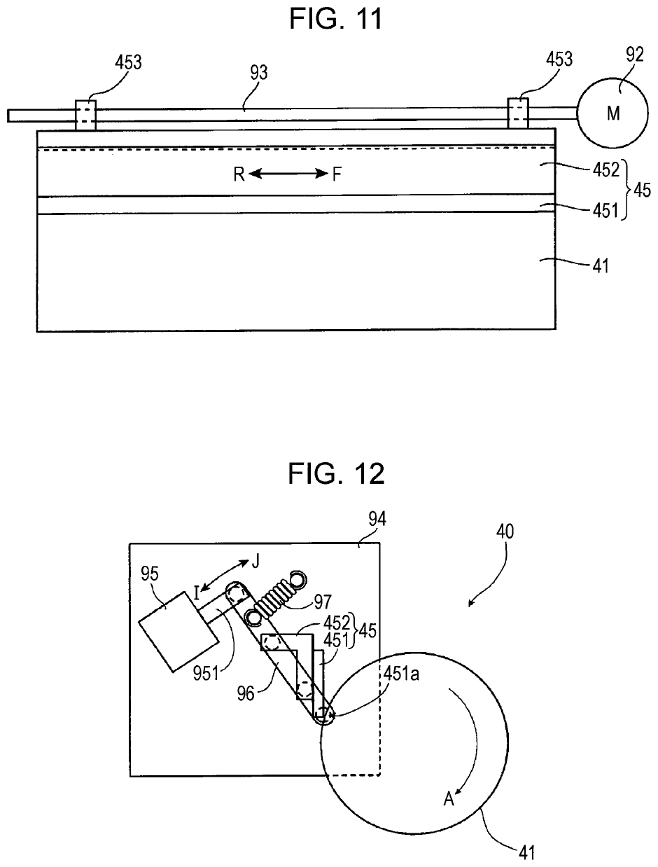

FIG. 11 is a side view showing the right sides of the cleaner and the image carrier as viewed from, for example, the left side in FIG. 10. Referring to FIG. 11, a fifth example of the flattening device of the present disclosure will be described.

FIG. 11 shows a motor 92 and a screw rod 93. The screw rod 93 has a male screw on the outer circumference thereof and rotates with the motor 92. Guide parts 453 having holes with female screws formed therein are provided on the support member 452 of the cleaner 45. The motor 92 is capable of rotation in the normal and reverse directions and is rotated so as to vibrate in the normal and reverse rotation directions. As a result, the cleaner 45 reciprocates so as to vibrate in the arrow F-R direction (in the direction perpendicular to the plane of the sheet of FIG. 10), thus flattening the toner dam 49 (see FIG. 2).

The fifth example shown in FIG. 11 is an example of a device that moves the image carrier and the scraper relative to each other in the rotation-axis direction of the image carrier, which serves as the relative movement device of the present disclosure.

FIG. 12 schematically shows an image forming engine. Referring to FIG. 12, a sixth example of the flattening device of the present disclosure will be described.

FIG. 12 shows a support plate 94 fixed to the housing of the copier 1 shown in FIG. 1, a plunger 95 supported by the support plate 94, a lever 96, and a coil spring 97. One end of the lever 96 is supported by the support plate 94 so as to be rotatable about a shaft that is coaxial with the contact portion 451A of the blade 451. The other end of the lever 96 is joined to the plunger 95. The cleaner 45 is fixed to the lever 96. The coil spring 97, which is supported by the support plate 94 at one end and is supported by the lever 96 at the other end, urges the lever 96 in the arrow J direction.

When the plunger 95 moves, a shaft 951 of the plunger 95 moves in the arrow I direction, rotating the lever 96. As the lever 96 rotates, the cleaner 45 rotates about the contact portion 451a.

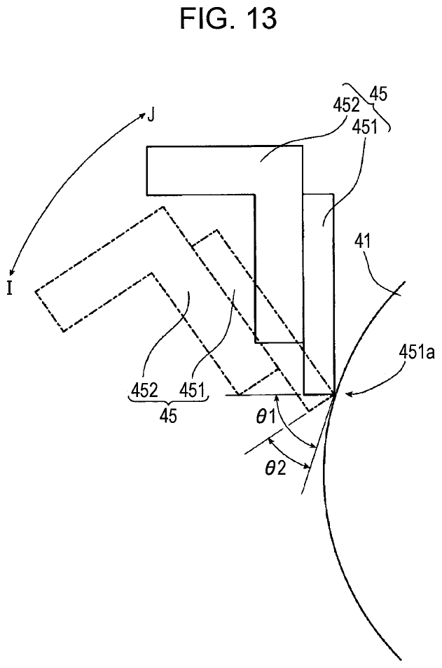

FIG. 13 schematically shows the cleaner before and after the rotation.

FIG. 13 shows, in a solid line, the cleaner 45 before rotation and shows, in a one-dot chain line, the cleaner 45 after the rotation. The angle formed between the image carrier 41 and the blade 451 of the cleaner 45 before rotation is the angle θ1, and the angle formed between the image carrier 41 and the blade 451 of the cleaner 45 after the rotation is the angle θ2, which is smaller than the angle θ1. The cleaner 45 rotated in the arrow I direction presses and flattens the toner dam 49 (see FIG. 2).

The sixth example shown in FIGS. 12 and 13 is an example of a device that presses and flattens a toner dam with the scraper, which serves as the relative movement device of the present disclosure.

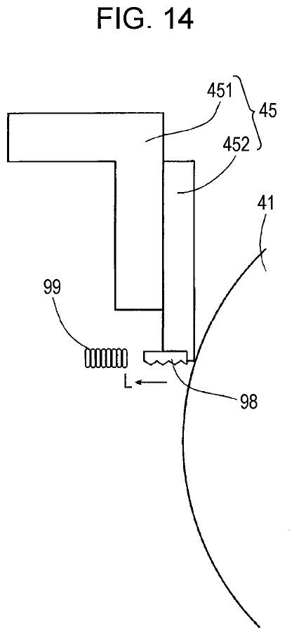

FIG. 14 is a schematic partial view of the cleaner of the image forming engine. Referring to FIG. 14, a seventh example of the flattening device of the present disclosure will be described.

FIG. 14 shows a ferromagnetic shape-memory member 98, which is disposed at an end of the blade 451 with which the toner dam 49 (see FIG. 2) is brought into contact, and an electromagnetic coil 99 that controls the magnetic field around the ferromagnetic shape-memory member 98. The ferromagnetic shape-memory member 98 is deformed by being influenced by the magnetic field. The ferromagnetic shape-memory member 98 is influenced by the magnetic field and is deformed so as to sweep out the toner dam 49 in the arrow L direction. As a result of the deformation of the ferromagnetic shape-memory member 98, the toner dam 49 is flattened.

The seventh example shown in FIG. 14 is an example of a device that flattens a pile of residue by moving in the direction of sweeping out the toner dam in the present disclosure.

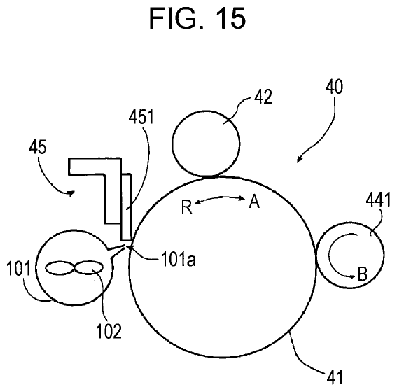

FIG. 15 schematically shows an image forming engine. Referring to FIG. 15, an eighth example of the flattening device of the present disclosure will be described.

FIG. 15 shows a pipe 101 that extends in the rotation-axis direction of the image carrier 41, and a fan 102 that is disposed at an end of the pipe 101 and supplies air to the pipe 101. The pipe 101 has a blowing port 101a through which the air supplied by the fan 102 is blown at the toner dam 49 (see FIG. 2). The flow rate of the air is controlled not to a level at which the toner dam 49 is blown away, but to a level at which the toner dam 49 is flattened.

The eighth example shown in FIG. 15 is an example of a device that flattens the pile of residue by blowing air in the present disclosure.

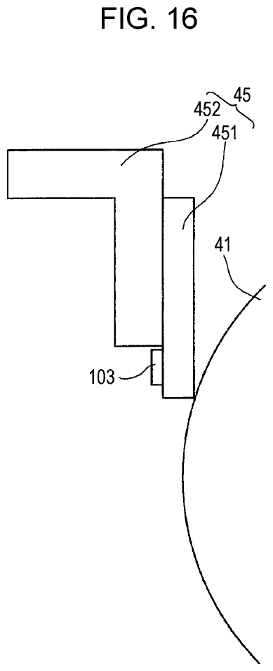

FIG. 16 is a schematic partial view of the cleaner of the image forming engine. Referring to FIG. 16, an example of the detector of the present disclosure will be described.

FIG. 16 shows a distortion sensor 103 that detects distortion of the blade 451.

In the first example, which has been described with reference to FIGS. 4 to 6, the rotation torque of the image carrier 41 is detected, and an operation of flattening the toner dam 49 is performed when the rotation torque has exceeded a threshold. The distortion sensor 103 is an alternative to the torque sensor, which detects the rotation torque of the image carrier 41, and is an example of the detector of the present disclosure.

When the friction between the image carrier 41 and the blade 451 increases, the blade 451 is distorted as the image carrier 41 rotates. The amount of distortion is detected with the distortion sensor 103, and, if the detected amount of distortion is greater than or equal to a threshold, an operation of flattening the toner dam 49 is executed. Compared with a case where the torque sensor is used, the use of the distortion sensor 103 makes it possible to directly know the distortion of the blade 451, that is, the friction between the image carrier 41 and the blade 451 and, thus, to more accurately know the time when the toner dam 49 needs to be flattened.

By using any one of the above-described example flattening devices, it is possible to flatten the toner dam 49, to promote passing of the external-additive particles, to suppress an increase in friction between the image carrier 41 and the blade 451, and thus, to suppress wear of the blade 451.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An image forming apparatus comprising:
an image carrier that carries a toner image on a surface thereof while rotating, from which the toner image is transferred to a transfer member;
a scraper that comes into contact with an area of the surface of the image carrier from which the toner image has been transferred and that scrapes residue off the image carrier; and
a flattening device that flattens a pile of residue that has been scraped off by the scraper and has accumulated.

2. The image forming apparatus according to claim 1, wherein the flattening device is a vibration applying device that vibrates the pile of residue accumulated in an accumulation area.

3. The image forming apparatus according to claim 2, further comprising:
a charger that comes into contact with the image carrier and charges the image carrier; and
a power applying device that applies, to the charger, image-carrier charging power including alternating power,
wherein the vibration applying device causes the power applying device to apply the alternating power whose amplitude or frequency has been increased.

4. The image forming apparatus according to claim 2, wherein the vibration applying device is a mechanical vibration device.

5. The image forming apparatus according to claim 1, wherein the flattening device is a relative movement device that causes the image carrier and the scraper to move relative to each other.

6. The image forming apparatus according to claim 5, wherein the relative movement device is a device that causes the image carrier to perform an operation including reverse rotation.

7. The image forming apparatus according to claim 5, wherein the relative movement device is a device that moves the image carrier and the scraper relative to each other in a rotation-axis direction of the image carrier.

8. The image forming apparatus according to claim 5, wherein the relative movement device is a device that presses and flattens the pile of residue with the scraper.

9. The image forming apparatus according to claim 1, wherein the flattening device is a device that flattens the pile of residue by moving in the direction of sweeping out the pile of residue, the device being disposed at a position in contact with the pile of residue and is supported by the scraper so as to be able to move in the direction of sweeping out the pile of residue from the accumulation area.

10. The image forming apparatus according to claim 1, wherein the flattening device is a device that flattens the pile of residue by blowing air at the accumulation area.

11. The image forming apparatus according to claim 1, wherein the scraper is in contact with the surface of the image carrier at a position where the moving direction of the surface of the image carrier has an upward component.

12. The image forming apparatus according to claim 1, further comprising a detector that detects whether the friction between the image carrier and the scraper has reached a level at which the flattening device is actuated.

13. The image forming apparatus according to claim 12, wherein the detector is a torque sensor that detects the rotation torque of the image carrier.

14. The image forming apparatus according to claim 12, wherein the detector is a distortion sensor that detects distortion of the scraper.

15. The image forming apparatus according to claim 1, wherein the image carrier has a surface protection layer, which has a higher hardness than an underlying layer and is formed of a material containing an element in group 13 of the periodic table, and holds a toner image on the surface of the surface protection layer.

16. The image forming apparatus according to claim 15, wherein the surface protection layer is composed of, at least, gallium and oxygen.

17. The image forming apparatus according to claim 15, wherein the surface protection layer contains hydrogen.

18. An image forming apparatus comprising:
image carrying means for carrying a toner image on a surface thereof while rotating, from which the toner image is transferred to transfer means;
scraping means that comes into contact with an area of the surface of the image carrier from which the toner image has been transferred and that scrapes residue off the image carrying means; and
flattening means for flattening a pile of residue that has been scraped off by the scraping means and has accumulated.
